(19) United States
(12) Patent Application Publication
(10) Pub. No.: US 2013/0328273 A1
(43) Pub. Date: Dec. 12, 2013

(54) INTERNAL OIL SEAL FOR ELECTRIC MOTORS

(71) Applicant: Bader AbdulRahman AL-JUWAIR, Alkhobar (SA)

(72) Inventor: Bader AbdulRahman AL-JUWAIR, Alkhobar (SA)

(21) Appl. No.: 13/489,840

(22) Filed: Jun. 6, 2012

(51) Int. Cl. F16J 15/447; F16J 15/453

(52) U.S. Cl. 277/412

(57) ABSTRACT

An oil seal for an end bearing of an electric motor with one or more internal cooling fans. The oil seal includes: (a) a non-contact floating ring seal, forming a first stage integrated into the bearing housing; (b) an adjacent labyrinth seal with three lands and two grooves, forming a second and third stage; and (c) air conduits that pressurize the groove of the third stage with air discharged from the stator during operation of the motor, forming an air seal room that inhibits the effect of fan suction that could otherwise draw oil from the bearing housing.

### BACKGROUND OF THE INVENTION

1. Field of the Invention

This invention relates to an internal seal for electric motors that provides a static seal between a rotatable shaft and a housing. In particular, the present invention relates to an axially-split labyrinth seal for an electric motor having an internal cooling fan.

2. Description of the Related Art

End bearings that support a motor's rotating shaft are typically provided with a seal that prevents oil from escaping from the bearing housing. A secondary, but important consideration is that the seal should inhibit contaminants from working their way into the housing.

The prior art includes metal sealing rings which are fixed to the bearing housing, the rings incorporating internal labyrinth-type grooves which tend to scrape oil moving axially along the shaft and thereby prevent the oil from escaping the housing. The prior art also includes floating seals that rotate with the shaft to retain the lubricant and exclude foreign matter, and floating shafts that do not rotate with the shaft.

If properly lubricated and foreign matter is prevented from contacting bearing surface(s), the life of the bearings can be prolonged. However, if the internal seal is ineffective and allows oil to escape from the housing, the life of the bearings may be greatly reduced. Similarly, if the internal seal allows contaminants to work their way into the housing, the contaminants can mix with the oil and cause premature wear of the bearings.

Oil can escape bearing housings through the outside of the motor or into contact with the motor's stator and/or rotor. In electric motors that incorporate internal cooling fans, oil leaks into the motor are a particular concern.

It is therefore an object of the present invention to provide an improved internal seal for an electric motor with an internal cooling fan that will inhibit oil from escaping the bearing housing.

### SUMMARY OF THE INVENTION

The above objects and other advantages are achieved by the present invention which comprehends an improved oil seal for an end bearing of an electric motor with one or more cooling fans that provides for greater retention of oil in the bearing housing, and which includes (a) a non-contact floating ring seal, forming a first stage; (b) a labyrinth seal with three lands and two grooves, forming a second stage (adjacent to the first stage) and a third stage (closest to the motor windings); and (c) conduits that pressurize the groove of the third stage closest to the internal fan with air removed from the stator housing during operation of the motor, via bore holes that communicate to the third stage, thus creating a seal air room.

The first, second and third stages, are axially split into upper and lower semi-circular sections for ease of assembly and mounted around the motor shaft and bolted together to form a unitary structure.

In a preferred embodiment, the lower semi-circular section of the labyrinth seal of the second and third stages is provided with a radial bore hole arranged for receiving an oil drain tube.

Any of various types of metals can be used in the present invention, including, for example, iron, steel, stainless steel, and aluminum. In a preferred embodiment, the oil seal is machined from aluminum.

### BRIEF DESCRIPTION OF THE DRAWINGS

The present invention will be further described in detail below and with reference to the attached drawings which are provided by way of illustration and example only, where the same or similar elements are referred to by the same number, and in which:

FIG. 1 is side view of an electric motor incorporating one embodiment of the invention;

FIG. 2A is a cross-sectional side view of the upper semi-circular sections of the three stages of the internal seal;

FIG. 2B is a cross-sectional side view of the lower semi-circular sections of the three stages of the internal seal;

FIG. 3 is a perspective view of the internal configuration of the second and third stages of the internal seal; and

FIG. 4 is a perspective view of the external configuration of the assembled internal seal.

### DETAILED DESCRIPTION OF THE INVENTION

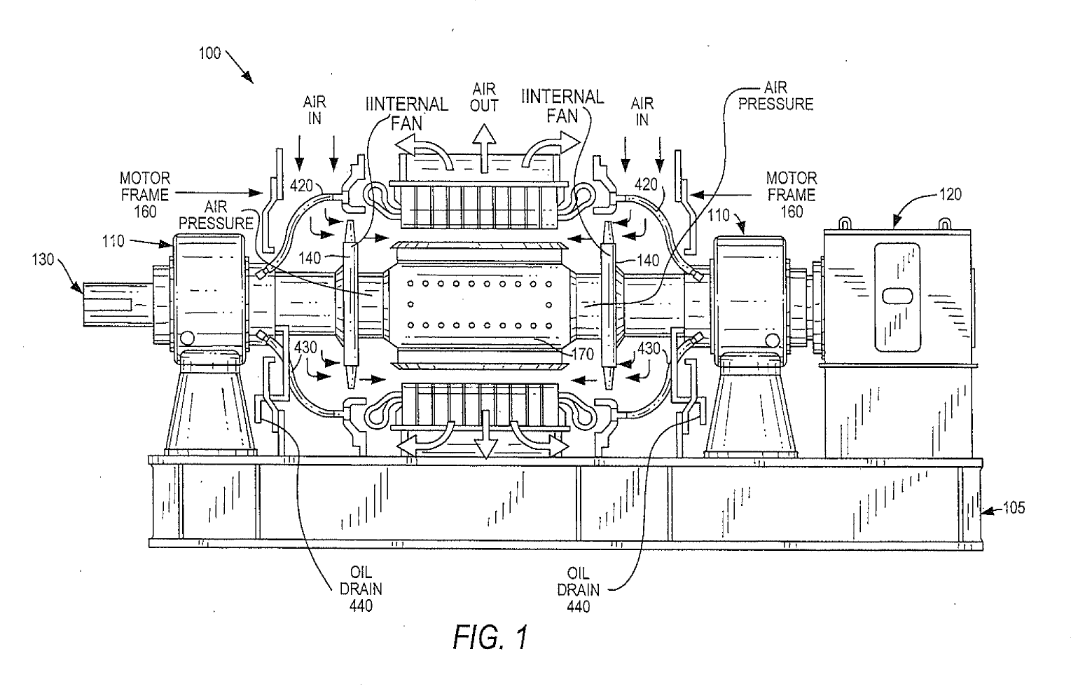

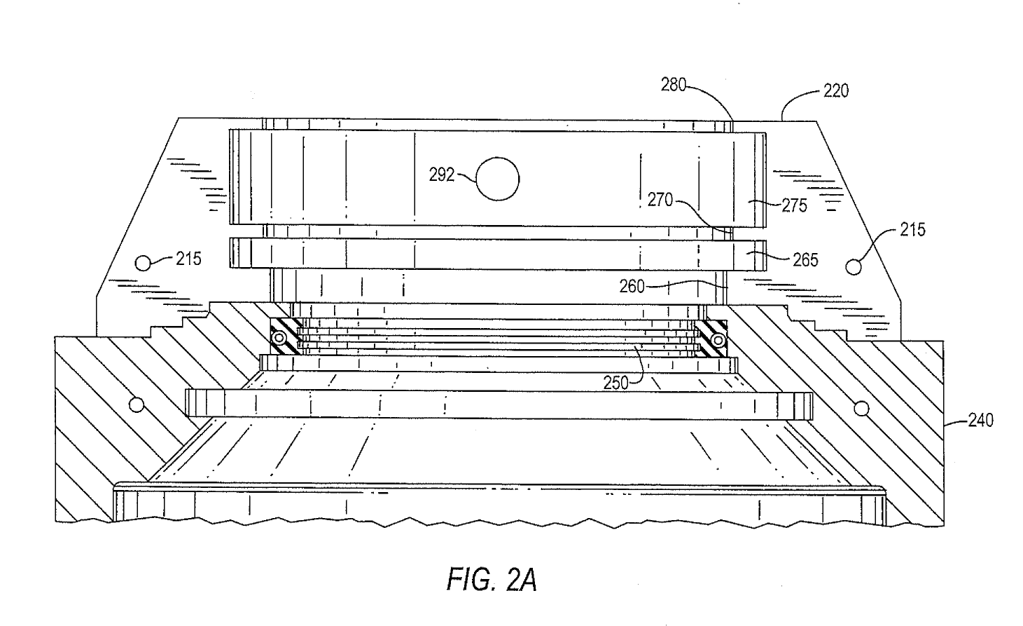

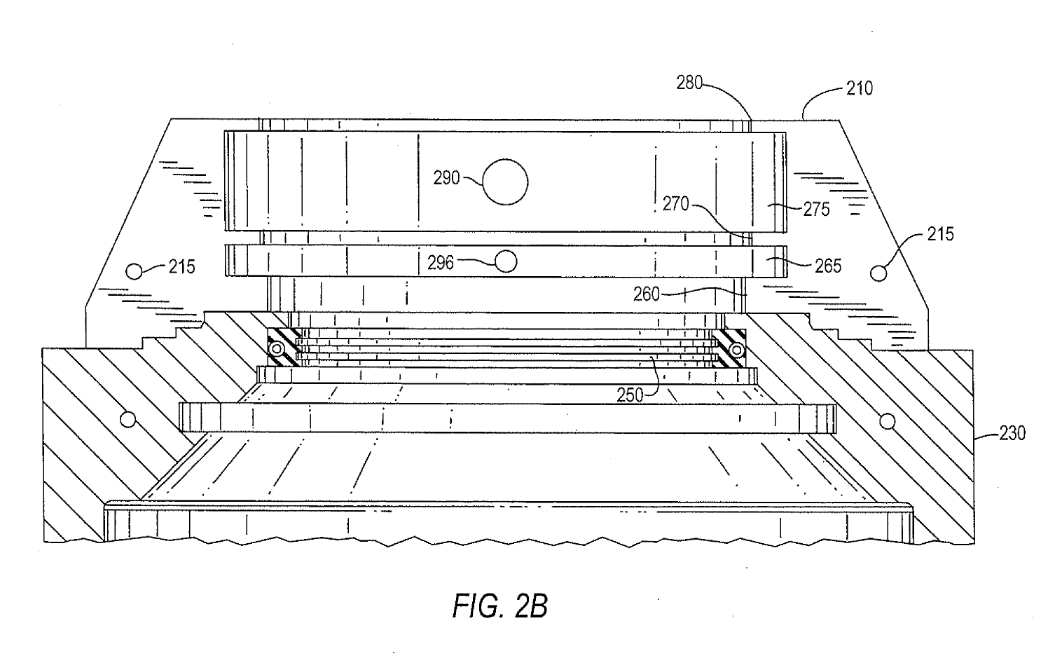

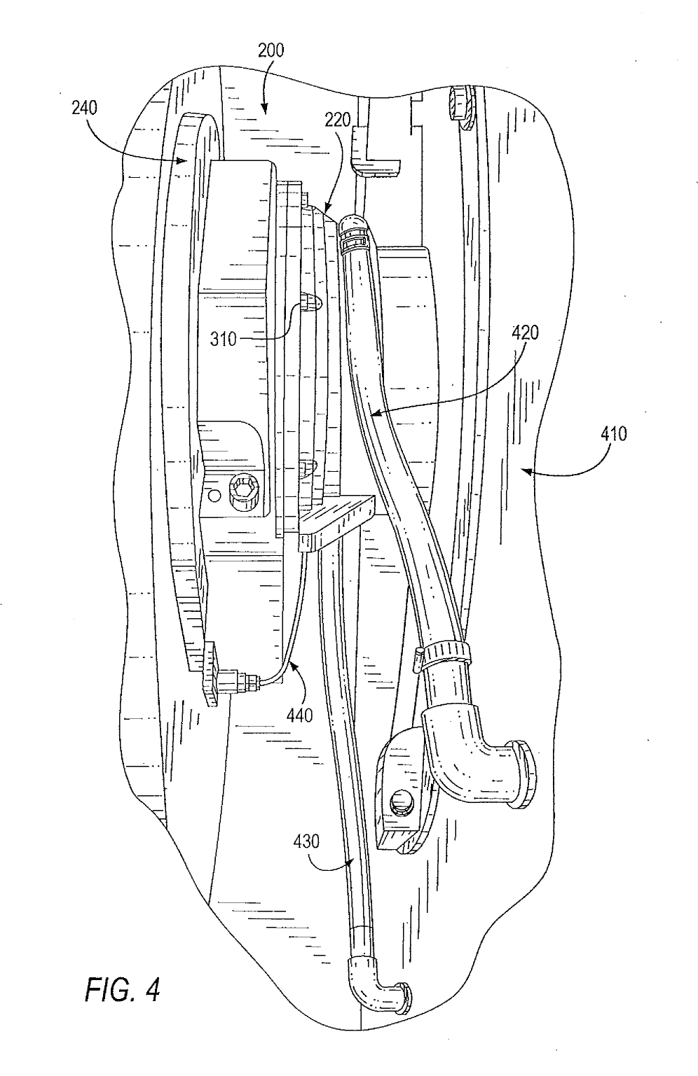

FIG. 1 illustrates one embodiment of the invention, in which a very large motor 100, for example 6500 HP, has its frame 160 mounted on skid 105. Shaft 130 is supported by two end bearings 110 that are situated outside motor frame 160. Terminal box 120 provides terminal blocks for electrical feeder cables. Internal fans 140 are mounted on shaft 130 and pull in outside air through intake vents in motor frame 160, which is directed to cool windings 170. The discharge air then exits through exhaust vents in motor frame 160. FIGS. 2 through 4 and the accompanying detailed description describe the oil seal provided for each end bearing 110. As may be seen in FIG. 1, the oil seal for end bearing 110 is provided with oil drain 440 and upper and lower air conduits 420 and 430, which are shown in greater detail in FIG. 4.

FIGS. 2A and 2B show the upper and lower semi-circular sections of the three stages of the oil seal. The upper semi-circular section 240 of the first stage can be seen in FIG. 2A, while the lower semi-circular section 230 of the first stage can be seen in FIG. 2B. Both FIGS. 2A and 2B show a preferred embodiment in which the first stage is incorporated into the bearing housing. The first stage includes a floating oil seal insert 250, such as a model commercially available from RENK AG, in which the seal is a two-piece design of rubber, polymer, etc., held together by a circumferential spring. An anti-rotation key molded into the housing of floating oil seal insert 250 is held in place in a keyway machined into the housing of the first stage, preventing the floating oil seal insert 250 from rotating. Therefore, the shaft (not shown) rotates through the seal i.e., the seal floats on the shaft, preferably picking up any oil which flows axially and draining it back into the bearing housing.

The internal seal 200 also includes a combined second and third stage, with the upper semi-circular section 220 of the combined second and third stages shown in FIG. 2A and the lower semi-circular section 210 of the combined second and third stages shown in FIG. 2B. The combined second and third stages are located adjacent (and bolted to) the side of the bearing housing closest the cooling fan and motor windings. The combined second and third stages comprise a labyrinth seal that provides a tortuous path that prevents leakage. Included are lands 260, 270, and 280, and grooves 265 and 275. Groove 265 forms the second stage, which is adjacent to the first stage semi-circular sections 230, 240. Groove 275 forms the third stage, which is closest to the motor windings. Lands 260, 270 and 280 press tightly against the rotating shaft, with a very small clearance between the shaft and the tip of each land. Any oil that escapes the first stage and passes land 260 will be drawn by centrifugal motion and the formation of controlled fluid vortices into groove 265. This acts to prevent its escape past land 270.

The lower semi-circular section 210 (FIG. 2B) and upper semi-circular section 220 (FIG. 2A) include two or more holes 215 for bolting the semi-circular sections together. Lower semi-circular section 210 includes bore hole 290 (FIG. 2B) in groove 275 of the third stage, and upper semi-circular section 220 (FIG, 2A) includes bore hole 292 in groove 275 of the third stage. Bore holes 290 and 292 are arranged for accepting air conduits to pressurize the third stage as an air seal room. In addition to the previously mentioned tight clearance between land 270 and the shaft, and the action of centrifugal force and the formation of controlled fluid vortices into groove 265, the pressurized air seal room of the third stage further prevents oil from being drawn out of the second stage via land 270.

FIG. 2B also shows that lower semi-circular section 210 includes a bore hole 296 in groove 265 of the second stage for receiving an oil drain tube. Thus, upper semi-circular section 220, as shown in FIG. 2A, is identical to lower semi-circular section 210, as shown in FIG. 2B, except that upper semi-circular section 220 does not require an oil drain tube bore hole comparable to 296.

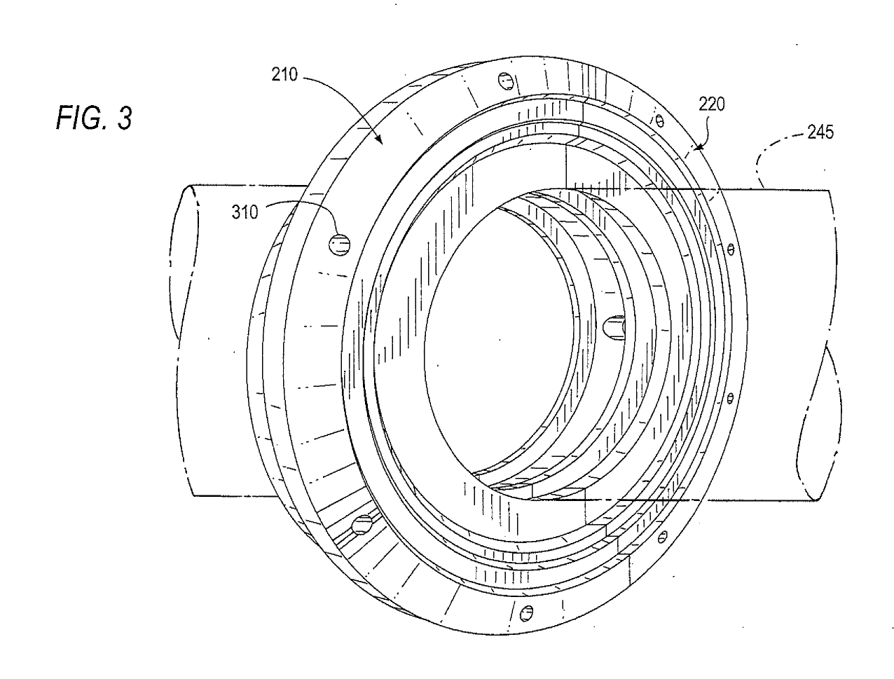

FIG. 3 shows a perspective view of lower and upper semi-circular sections 210 and 220, joined together as they would be when mounted around the motor shaft 245. As noted above, lower semi-circular section 210 and upper semi-circular section 220 include two or more holes 215 (shown in FIGS. 2A and 2B) for bolting the semi-circular sections together. FIG. 3 also shows that lower and upper semi-circular sections 210 and 220 are provided with holes 310 for bolting the sections 210 and 220 to the bearing housing.

FIG. 4 shows the assembled internal seal 200, with upper semi-circular section 240 of the first stage (incorporated into the bearing housing). In this figure, lower semi-circular section 230 of the first stage is not visible, being placed behind and bolted to upper semi-circular section 240 of the first stage. Similarly, upper semi-circular section 220 of the combined second and third stages is shown. Lower semi-circular section 210 of the combined second and third stages is not shown in this figure, since it is positioned behind and bolted to upper semi-circular section 220 of the combined second and third stages. Bolt holes 310 may be seen, by which the semi-circular sections 210 and 220 of the combined second and third stages are bolted to the bearing housing.

Oil drain line 440 extends from bore hole 296 of the lower semi-circular section 210 (not shown). Any oil that escapes past the first stage to the second stage will drain through bore hole 296 and oil drain line 440 due to gravity. Oil drain line 440 extends to outside the motor, to a convenient place where maintenance staff can observe if a leak is present.

One end of air conduits 420 and 430 terminate penetrations of wall 410 of the motor frame, where they draw pressure produced by the internal fans. The other ends of air conduits 420 and 430 terminate, respectively, at bores hole 292 and 290 (not shown) of the upper and lower semi-circular sections of the second and third stages, where they pressurize the air seal room.

As noted previously, the first stage and also the labyrinth seal of the second and third stages are each split into upper and lower semi-circular sections for ease of assembly around the motor shaft. For the labyrinth seal of the second and third stages, the orientation of the upper and lower semi-circular sections 210, 220 is important, as bore hole 296 should be positioned closest to the ground, allowing any oil leak to escape through the action of gravity. Bore holes 290 and 292 are arranged for accepting air conduits to pressurize the third stage as an air seal room.

The orientation of the upper and lower semi-circular sections 230, 240 for the first stage does not matter, except as noted upper and lower semi-circular sections 210, 220 are supplied with holes 310 for bolting the sections 210 and 220 to the bearing housing.

The present invention has been described in the foregoing specification with reference to specific embodiments. It will, however, be evident to one of ordinary skill in the art that various modifications and additions can be made without departing from the broader scope of the invention, which is to be determined by reference to the claims that follow. The specification and drawings are, accordingly, to be regarded in an illustrative rather than a restrictive sense.

1. A three-stage end bearing oil seal assembly for a rotating machine, the assembly comprising:
a separate first piece being an upper semi-circular section of the first stage;
a separate second piece being a lower semi-circular section of the first stage, the separate second piece together with the separate first piece forming a non-contact floating ring seal;
a separate third piece being an upper semi-circular section of the second and third stages; and
a separate fourth piece being a lower semi-circular section of the second and third stages, the separate fourth piece together with the separate third piece forming a labyrinth seal with three lands and two grooves, one groove defining the second stage and the other groove defining the third stage, in which the separate third piece and the separate fourth piece are each provided with a bore hole that is in fluid communication with the groove of the third stage, each bore hole fitted with an air conduit for receiving pressurized air to pressurize the groove of the third stage with air discharged from the stator during operation of the motor;
wherein the rotating machine is an electric motor;
wherein the electric motor comprises an internal fan; and
wherein the first stage is proximate the end bearings of the electric motor and the third stage is proximate the internal fan.

2. The oil seal assembly of claim 1 in which the separate fourth piece is provided with a bore that is in fluid communication with the groove of the second stage, the bore arranged for receiving an oil drain tube.

3. The oil seal assembly of claim 1, in which the separate first piece, separate second piece, separate third piece, and separate fourth piece are machined from aluminum.

4. The oil seal assembly of claim 2, in which the separate first piece, separate second piece, separate third piece, and separate fourth piece are machined from aluminum.

5. The oil seal assembly of claim 1, in which the separate first piece and the separate second piece are integrated into an end bearing housing.

6. The oil seal assembly of claim 2, in which the separate first piece and the separate second piece are integrated into an end bearing housing.

7. The oil seal assembly of claim 3, in which the separate first piece and the separate second piece are integrated into an end bearing housing.

8. The oil seal assembly of claim 4, in which the separate first piece and the separate second piece are integrated into an end bearing housing.
